(19) United States
(12) Patent Application Publication
(10) Pub. No.: US 2019/0087921 A1
(43) Pub. Date: Mar. 21, 2019

(54) FATIGUE DEFORMATION EVOLUTION MODEL OF CONCRETE BASED ON WEIBULL FUNCTION

(71) Applicant: ZHEJIANG UNIVERSITY, Zhejiang (CN)

(72) Inventors: Qinghua LI, Zhejiang (CN); Botao HUANG, Zhejiang (CN); Shilang XU, Zhejiang (CN)

(21) Appl. No.: 15/871,269

(22) Filed: Jan. 15, 2018

(30) Foreign Application Priority Data
Sep. 19, 2017 (CN) 201710844695.5

(51) Int. Cl. G06Q 50/08; G06F 17/18; G01B 21/32; G01N 3/56

(52) U.S. Cl. CPC G06Q 50/08; G01N 3/565; G01B 21/32; G06F 17/18

(57) ABSTRACT

The present invention discloses a fatigue deformation evolution model of concrete based on Weibull function. With the continuous development of modern civil engineering, the fatigue performance of concrete materials has become one of the focuses of concern. The accurate characterization of concrete fatigue performance evolution and prediction of fatigue life of concrete has become an important issue in the field of engineering construction. The model provided by the invention can be used to characterize the concrete deformation evolution law under the compressive, tensile and flexural fatigue loads, having the advantages of diverse applicable forms of loads, simple expression, simpleness to use and high accuracy, etc. During the use, it can greatly reduce the computations, and only two fatigue parameters of the number of fatigue load cycles n and the deformation ε corresponding to the stress of the n^{th} cycle need to be measured, which simplifies the monitoring equipment. The model can provide an important technical support for engineering design, construction, monitoring and maintenance.

### FIELD OF THE INVENTION

The present invention relates to a fatigue deformation evolution model of concrete.

### BACKGROUND

Since the advent of Portland cement in the 19^{th} century, concrete has been widely used in such fields as transportation, construction, water conservancy and marine engineering. It is the material used most widely in the engineering construction. In the early 20^{th} century, with the construction of reinforced concrete bridges, the related researches on the fatigue performance of concrete materials are gradually carried out. Since the 21^{st} century, with the construction of large-scale infrastructures such as highways, high-speed railways, super high-rise buildings, special high dams, cross-sea bridges and offshore platforms, concrete structures are faced with more complicated and harsh service conditions such as cyclic loads and alternating environments, etc. In addition, with the further development of the theory of concrete structure design and the popularization and application of high-strength concrete, the stress level of concrete is gradually increased during the service of the structure, which makes fatigue failure of concrete more likely. Therefore, in the continuous development of modern civil engineering, the fatigue performance of concrete materials has become one of the focuses of concern. How to accurately characterize the fatigue performance evolution and predict the fatigue life of concrete becomes an important issue in engineering design, construction, monitoring and maintenance. The existing characterization of fatigue performance and fatigue life prediction of concrete materials are mainly based on the evolution of materials' fatigue damage. For the role of compressive, tensile and flexural fatigue loads, researchers have developed a series of fatigue models respectively. These models establish the fatigue damage relationship mainly through the attenuation of materials' elastic modulus, and based on this, establish the complex fatigue performance characterization and life prediction model. Existing models usually need to include many parameters such as fatigue strain, fatigue stress, elastic modulus and materials' fitting parameters. The model is complicated and generally needs to be iteratively calculated. Thus, it is difficult to popularize and apply it in engineering construction. Therefore, it is very urgent to propose a concrete fatigue evolution model with fewer variables whose parameters are easily determined and with high precision that is not affected by load forms, which can provide important technical support for engineering design, construction, monitoring and maintenance.

### SUMMARY

The object of the present invention is to provide a fatigue deformation evolution model with simple expression, simpleness to use and high accuracy. To this end, the prevent invention employs the following technical solutions.

A fatigue deformation evolution model of concrete based on Weibull function, wherein the number of fatigue load cycles n of a concrete under the fatigue load at one certain stress level and the deformation ε corresponding to one of the stresses of the n^{th} fatigue load cycle are expressed by the following equation:

n/N_{f}=1−exp(−((ε−ε₀)/λ)^{k})

wherein, N_{f} is fatigue life, ε₀ is position parameter, λ is scale parameter, k is shape parameter.

Further, the stress is larger than or equal to zero, and smaller than or equal to maximum stress of the fatigue load.

Further, the fatigue load may be a compressive fatigue load, a tensile fatigue load or a flexural fatigue load.

If several (i) number of fatigue load cycles n and the deformations ε corresponding to one of the stresses of the n^{th} fatigue load cycle are known, i.e. (ε₁, n₁), (ε₂, n₂), (ε₃, n₃), . . . , (εᵢ, nᵢ), the fatigue life N_{f}, position parameter ε₀, scale parameter λ, and shape parameter k can be obtained by fitting, on the basis of the above i groups of data. In addition, when the fatigue life N_{f} is known, the other parameters can be obtained by the same method.

Further, the deformation ε is a maximum deformation εₛ when said one of the stresses is the maximum stress of the fatigue load; the number of fatigue load cycles n and the maximum deformation εₛ of the n^{th} fatigue load cycle of the concrete under a fatigue load at one certain stress level can be expressed as follows:

n/N_{f}=1−exp(−((εₛ−εₛ₀)/λₛ)^{k}^{ₛ})

wherein, N_{f} is fatigue life, εₛ₀ is position parameter, λₛ is scale parameter, kₛ is shape parameter. An optional value for position parameter εₛ₀ is the deformation corresponding to the maximum stress of the first fatigue load cycle of the concrete.

Further, the deformation ε is the residual deformation εₚ when said one of the stresses is zero; the number of fatigue load cycles n and the residual deformation εₚ of the n^{th} fatigue load cycle of the concrete under a fatigue load at one certain stress level can be expressed as follows:

n/N_{f}=1−exp(−((εₚ−εₚ₀)/λₚ)^{k}^{ₚ})

wherein, N_{f} is fatigue life, εₚ₀ is position parameter, λₚ is scale parameter, kₚ is shape parameter. An optional value of the position parameter εₚ₀ is zero, and another optional value is the residual deformation of the concrete after the first cycle of the fatigue load.

Further, when one of the shape parameters kₛ and kₚ is a known value, the value of the other parameter may be equal to the known value.

The invention provides a fatigue deformation evolution model of concrete based on Weibull function, which is used to characterize the law of deformation evolution of concrete under compressive, tensile and flexural fatigue loads. It has the advantages of diverse applicable forms of loads, simple expression, simpleness to use and high accuracy, etc. During the use, it can greatly reduce the computations, and only two fatigue parameters of number of fatigue load cycles n and the deformation ε corresponding to the stress of the n^{th} cycle need to be measured, which simplifies the monitoring equipment. The model can provide an important technical support for engineering design, construction, monitoring and maintenance.

### BRIEF DESCRIPTION OF THE DRAWINGS

FIG. 1 shows the experimental results and model results of the maximum deformation and residual deformation evolution of concrete under the compressive fatigue load according to Example 1 of the present invention.

FIG. 2 shows the experimental results and model results of the maximum deformation and residual deformation evolution of concrete under the tensile fatigue load according to Example 2 of the present invention.

FIG. 3 shows the experimental results and model results of the maximum deformation and residual deformation evolution of concrete subjected to flexural fatigue load according to Example 3 of the present invention.

### DETAILED DESCRIPTION

The present invention is further described in combination with drawings and specific embodiments. The embodiments are intended to illustrate the present invention, but not to limit the invention in any way.

### Example 1

This example uses the fatigue deformation result of concrete compressive fatigue specimen D22 in “FIG. 11” of the document “Holmen J O. Fatigue of concrete by constant and variable amplitude loading. ACI Special Publication, 1982, 75: 71-110”. The evolution law of the maximum deformation εₛ and residual deformation εₚ under the compressive fatigue load are shown in FIG. 1. It should be noted that, the maximum deformation εₛ of the fatigue specimen is obtained directly from the document, and the residual deformation εₚ is calculated from the fatigue deformation results in the document.

According to the experimental values of maximum deformation εₛ shown in FIG. 1, the position parameter εₛ₀=0.09582, scale parameter λₛ=0.11497, and shape parameter kₛ=3.16309 can be obtained by fitting, so as to obtain the following fatigue deformation evolution model.

n/N_{f}=1−exp(−((εₛ−0.09582)/0.11497)^{3.16309}), (r²=0.9971)

According to the experimental values of residual deformation εₚ shown in FIG. 1, the position parameter εₚ₀=0.01483, scale parameter λₚ=0.09422, and shape parameter kₚ=3.27520 can be obtained by fitting, so as to obtain the following fatigue deformation evolution model.

n/N_{f}=1−exp(−((εₚ−0.01483)/0.09422)^{3.27520}), (r²=0.9991)

The fatigue deformation evolution model results obtained are highly correlated to the experimental values, which can accurately characterize the evolution law of compression fatigue deformation, as shown in FIG. 1.

### Example 2

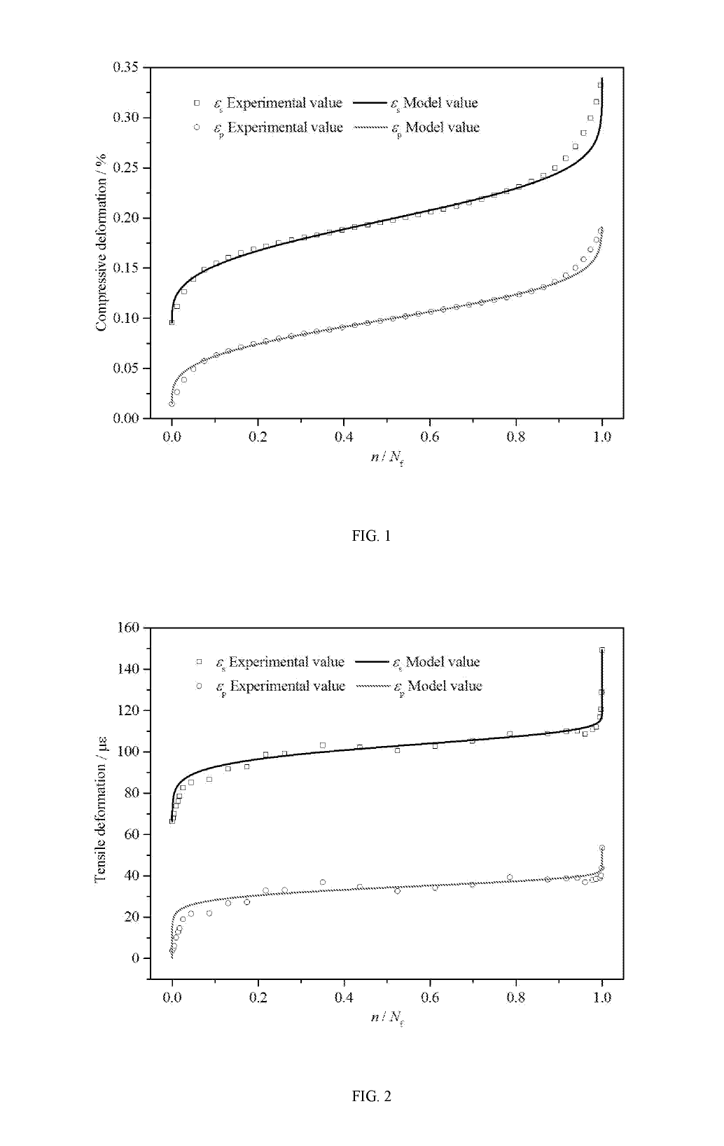

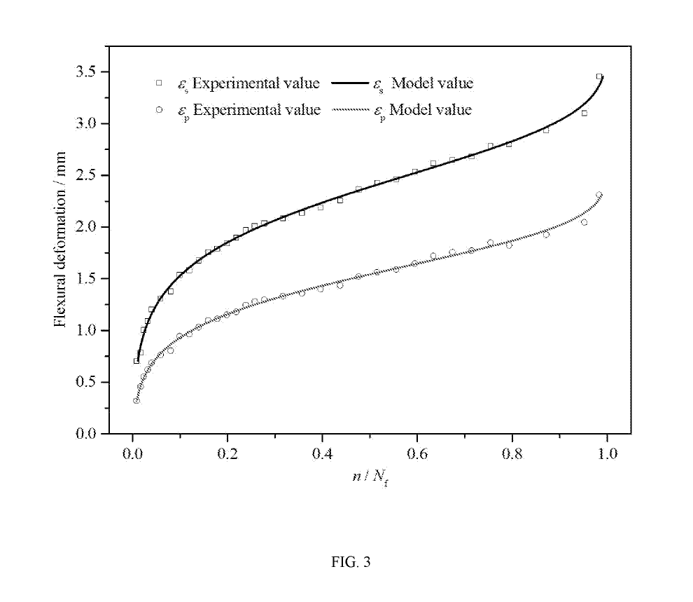

This example uses the fatigue deformation results of concrete tensile fatigue specimen S=0.85 test data in “FIG. 8c” of the document “Chen X, Bu J, Fan X, et al. Effect of loading frequency and stress level on low cycle fatigue behavior of plain concrete in direct tension. Construction and Building Materials, 2017, 133: 367-375”. The evolution law of the maximum deformation εₛ and residual deformation εₚ under the tensile fatigue load are shown in FIG. 2. It should be noted that, both the maximum deformation εₛ and the residual deformation εₚ of the fatigue specimen are obtained directly from the document.

According to the experimental values of maximum deformation εₛ shown in FIG. 2, the position parameter εₛ₀=38.21874, scale parameter λₛ=66.41625, shape parameter kₛ=11.44255 can be obtained by fitting, so as to obtain the following fatigue deformation evolution model.

n/N_{f}=1−exp(−((εₛ−38.21874)/66.41625)^{11.44255}), (r²=0.9769)

According to the experimental values of residual deformation εₚ shown in FIG. 2, the position parameter εₚ₀=−2.14727, scale parameter λₚ=37.79211, shape parameter kₚ=10.44414 can be obtained by fitting, so as to obtain the following fatigue deformation evolution model.

n/N_{f}=1−exp(−((εₚ+2.14727)/37.79211)^{10.44414}), (r²=0.9188)

The fatigue deformation evolution model results obtained are highly correlated to the experimental values, which can accurately characterize the evolution law of tensile fatigue deformation, as shown in FIG. 2.

### Example 3

This example uses the fatigue deformation result of fiber concrete flexural fatigue specimens S0.80 in “FIG. 3a” of the document “Liu W, Xu S, Li H. Flexural fatigue damage model of ultra-high toughness cementitious composites on base of continuum damage mechanics. International Journal of Damage Mechanics, 2014, 23(7): 949-963”. The evolution law of the maximum deformation εₛ and residual deformation εₚ under the flexural fatigue load are shown in FIG. 3. It should be noted that, the maximum deformation εₛ of the fatigue specimen is obtained directly from the document, and the residual deformation εₚ is calculated from the fatigue deformation results in the document.

According to the experimental values of maximum deformation εₛ shown in FIG. 3, the position parameter εₛ₀=−2.27807, scale parameter λₛ=4.85335, shape parameter kₛ=9.28728 can be obtained by fitting, so as to obtain the following fatigue deformation evolution model.

n/N_{f}=1−exp(−((εₛ+2.27807)/4.85335)^{9.28728}), (r²=0.9983)

According to the experimental values of residual deformation εₚ shown in FIG. 3, the position parameter εₚ₀=−1.30373, scale parameter λₚ=2.98369, shape parameter kₚ=7.78920 can be obtained by fitting, so as to obtain the following fatigue deformation evolution model.

n/N_{f}=1−exp(−((εₚ+1.30373)/2.98369)^{7.78920}), (r²=0.9965)

The fatigue deformation evolution model results obtained are highly correlated to the experimental values, which can accurately characterize the evolution law of flexural fatigue deformation, as shown in FIG. 3.

What is claimed is:

1. A fatigue deformation evolution model of concrete based on Weibull function, wherein the number of fatigue load cycles n of a concrete under the fatigue load at one certain stress level and the deformation ε corresponding to one of the stresses of the n^{th} fatigue load cycle are expressed by the following equation:
n/N_{f}=1−exp(−((ε−ε₀)/λ)^{k})
wherein, N_{f} is fatigue life, ε₀ is position parameter, λ is scale parameter, k is shape parameter.

2. The fatigue deformation evolution model of concrete based on Weibull function according to claim 1, wherein said one of the stresses is larger than or equal to zero, and smaller than or equal to the maximum stress of the fatigue load.

3. The fatigue deformation evolution model of concrete based on Weibull function according to claim 1, wherein the fatigue load may be a compressive fatigue load, a tensile fatigue load or a flexural fatigue load.

4. The fatigue deformation evolution model of concrete based on Weibull function according to claim 1, wherein the fatigue life N_{f}, position parameter ε₀, scale parameter λ, and shape parameter k can be obtained by fitting, on the basis of several of the measured deformations ε and the corresponding number of fatigue load cycles n.

5. The fatigue deformation evolution model of concrete based on Weibull function according to claim 1, wherein the deformation ε is a maximum deformation εₛ when said one of the stresses is the maximum stress of the fatigue load; the number of fatigue load cycles n and the maximum deformation εₛ of the n^{th} fatigue load cycle of the concrete under the fatigue load at one certain stress level can be expressed as follows:
n/N_{f}=1−exp(−((εₛ−εₛ₀)/λₛ)^{k}^{ₛ})
wherein, N_{f} is fatigue life, εₛ₀ is position parameter, λₛ is scale parameter, kₛ is shape parameter.

6. The fatigue deformation evolution model of concrete based on Weibull function according to claim 5, wherein an optional value for the position parameter εₛ₀ is the deformation corresponding to the maximum stress of the first fatigue load cycle of the concrete.

7. The fatigue deformation evolution model of concrete based on Weibull function according to claim 1, wherein the deformation ε is a residual deformation εₚ when said one of the stresses is 0; the number of fatigue load cycles n and the residual deformation εₚ of the n^{th} fatigue load cycle of the concrete under the fatigue load at one certain stress level can be expressed as follows:
n/N_{f}=1−exp(−((εₚ−εₚ₀)/λₚ)^{k}^{ₚ})
wherein, N_{f} is fatigue life, εₚ₀ is position parameter, λₚ is scale parameter, kₚ is shape parameter.

8. The fatigue deformation evolution model of concrete based on Weibull function according to claim 7, wherein an optional value of the position parameter εₚ₀ is 0, and another optional value is the residual deformation of the concrete after the first cycle of the fatigue load.

9. The fatigue deformation evolution model of concrete based on Weibull function according to claim 1, wherein
the deformation ε is the maximum deformation εₛ when said one of the stresses is the maximum stress of the fatigue load; the number of fatigue load cycles n and the maximum deformation εₛ of the n^{th} fatigue load cycle of the concrete under a fatigue load at one certain stress level can be expressed as follows:
n/N_{f}=1−exp(−((εₛ−εₛ₀)/λₛ)^{k}^{ₛ})
wherein, N_{f} is fatigue life, εₛ₀ is position parameter, λₛ is scale parameter, kₛ is shape parameter;
The deformation ε is the residual deformation εₚ when said one of the stresses is 0; the number of fatigue load cycles n and the residual deformation εₚ of the n^{th} fatigue load cycle of the concrete under a fatigue load at one certain stress level can be expressed as follows:
n/N_{f}=1−exp(−((εₚ−εₚ₀)/λₚ)^{k}^{ₚ})
wherein, N_{f} is fatigue life, εₚ₀ is position parameter, λₚ is scale parameter, kₚ is shape parameter;
When one of the shape parameters kₛ and kₚ is a known value, the value of the other parameter may be equal to the known value.
